(19) United States
(12) Patent Application Publication
(10) Pub. No.: US 2021/0184211 A1
(43) Pub. Date: Jun. 17, 2021

(54) POSITIVE ELECTRODE MATERIAL FOR LITHIUM SECONDARY BATTERY AND LITHIUM SECONDARY BATTERY INCLUDING THE SAME

(71) Applicants: Hyundai Motor Company, Seoul (KR); Kia Motors Corporation, Seoul (KR); Industry Academy Cooperation Foundation of Sejong University, Seoul (KR)

(72) Inventors: Seung Min Oh, Incheon (KR); Sang Mok Park, Gwangju (KR); Ik Kyu Kim, Gwangmyeong (KR); Yeol Mae Yeo, Hwaseong (KR); Yoon Sung Lee, Suwon (KR); Dong Jun Kim, Seongnam (KR); Sa Heum Kim, Suwon (KR); Ji Eun Lee, Hwaseong (KR); Seung Taek Myung, Seoul (KR); Ji Ung Choi, Seoul (KR)

(21) Appl. No.: 16/883,580

(22) Filed: May 26, 2020

(30) Foreign Application Priority Data
Dec. 16, 2019 (KR) 10-2019-0167917

(51) Int. Cl. H01M 4/505; H01M 4/131; H01M 10/0525; H01M 4/134

(52) U.S. Cl. CPC H01M 4/505; H01M 4/131; H01M 2004/027; H01M 4/134; H01M 10/0525

(57) ABSTRACT

Provided are, inter alia, a positive electrode material for a lithium secondary battery having a high energy density with only a single positive electrode material, and a lithium secondary battery including the same. The positive electrode material for a lithium secondary battery includes a positive electrode active material formed of a Li—[Mn—Ti]—O-based material so that lithium is reversibly intercalated and deintercalated, and particularly, the positive electrode active material is doped with a dopant (Me) having an oxidation number of 2 to 6.

### CROSS REFERENCE TO RELATED APPLICATION

The present application claims priority to Korean Patent Application No. 10-2019-0167917, filed Dec. 16, 2019, the entire contents of which is incorporated herein for all purposes by this reference.

### TECHNICAL FIELD

The present invention relates to a positive electrode material for a lithium secondary battery and a lithium secondary battery including the same. The positive electrode material for a lithium secondary battery may have a high energy density with only a single positive electrode material.

### BACKGROUND

A secondary battery has been used as either a large capacity power storage battery for an electric vehicle or a battery power storage system or a small high-performance energy source for a portable electronic device such as a mobile phone, a camcorder, a laptop, or the like. Thus, a research for reducing a weight of a part and implementing a low power consumption, and a secondary battery having a high capacity in spite of its small size have been required in order to implement a small size and long-term continuous use of a portable electric device.

In particular, the lithium secondary battery as of a representative secondary battery has greater energy density, greater capacity per area, less self-discharge rate, and longer lifespan than a nickel-manganese battery or a nickel-cadmium battery. In addition, the lithium secondary battery is convenient to use and has a long lifespan due to the absence of memory effects.

In the lithium secondary battery, in a state in which an electrolyte is filled between a positive electrode and a negative electrode which are formed of active materials capable of intercalating and deintercalating lithium ions, electrical energy is produced by oxidation and reduction reactions when the lithium ions are intercalated/deintercalated into/from the positive electrode and the negative electrode.

The lithium secondary battery includes a positive electrode material, an electrolyte, a separator, a negative electrode material, and the like, and it is important for the lithium secondary battery to stably maintain an interfacial reaction between the components in order to ensure the long lifespan and reliability of the battery.

A research for improving a positive electrode material has been consistently carried out in order to improve the performance of the lithium secondary battery. In particular, many researches for developing a lithium secondary battery with high performance and high stability have been carried out. However, in recent years, stability issues have been constantly raised due to frequent explosion accidents from lithium secondary batteries.

Accordingly, the present applicant has completed the present invention based on the fact that when a lithium-rich material is used, a high capacity of 250 mAh/g or greater in a voltage range of 2 to 4.2 V is implemented, and a lithium secondary battery having a high energy density may be thus implemented.

The contents described as the related art have been provided only for assisting in the understanding for the background of the present invention and should not be considered as corresponding to the related art known to those skilled in the art.

### SUMMARY

In preferred aspects, provided are a positive electrode material for a lithium secondary battery that may implement greater discharge capacity than a conventional positive electrode by doping a transition metal and a lithium secondary battery including the same.

In one aspect, provided is a positive electrode material for a lithium secondary battery includes a positive electrode active material including a Li—[Mn—Ti]—O-based material and a dopant (Me) having an oxidation number of 2 to 6. Preferably, the positive electrode active material may include the Li—[Mn—Ti]—O-based material doped with the dopant (Me). The lithium is reversibly intercalated and deintercalated by the positive electrode active material.

The positive electrode material may include Li_{1.2+y}[Mn_{0.4}Ti_{0.4}]₁₋ₓMeₓO₂, the dopant (Me) may be one or more selected from W, Cr, Al, Ni, Fe, Co, V, andZn, a nd 0.025≤x≤0.0 and −0.02≤y≤0.02.

In another aspect, provided is a lithium secondary battery that may include: a positive electrode including a positive electrode material including a positive electrode active material as described herein, for example, which includes a Li—[Mn—Ti]—O-based material and a dopant (Me) having an oxidation number of 2 to 6; a negative electrode including a negative electrode active material; and an electrolyte. Preferably, lithium can be reversibly intercalated and deintercalated, the positive electrode active material may include the Li—[Mn—Ti]—O-based material doped with the dopant (Me).

### BRIEF DESCRIPTION OF THE DRAWINGS

FIG. 1 is a diagram illustrating a result of an X-ray diffraction analysis of an exemplary positive electrode material in which impurities are formed due to an excessive amount of Li.

FIG. 2 is a diagram illustrating a result of an X-ray diffraction analysis of an exemplary positive electrode material according to each of Examples and Comparative Examples.

FIG. 3 is SEM photographs illustrating exemplary positive electrode materials according to various exemplary embodiments of the present invention.

FIG. 4 is a graph illustrating results of evaluating electrochemical properties of an exemplary positive electrode active material in Example 1 according to an exemplary embodiment of the present invention.

FIG. 5 is a graph illustrating results of evaluating electrochemical properties of an exemplary positive electrode active material in Example 2 according to an exemplary embodiment of the present invention.

FIG. 6 is a graph illustrating results of evaluating electrochemical properties of an exemplary positive electrode active material in Example 3 according to an exemplary embodiment of the present invention.

FIG. 7 is a graph illustrating results of evaluating electrochemical properties of an exemplary positive electrode active material in Example 4 according to an exemplary embodiment of the present invention.

FIG. 8 is a graph illustrating results of evaluating electrochemical properties of an exemplary positive electrode active material in Example 5 according to an exemplary embodiment of the present invention.

FIG. 9 is a graph illustrating results of evaluating electrochemical properties of an exemplary positive electrode active material in Example 6 according to an exemplary embodiment of the present invention.

FIG. 10 is a graph illustrating results of evaluating electrochemical properties of an exemplary positive electrode active material in Example 7 according to an exemplary embodiment of the present invention.

FIG. 11 is a graph illustrating results of evaluating electrochemical properties of an exemplary positive electrode active material in Example 8 according to an exemplary embodiment of the present invention.

FIG. 12 is a graph illustrating results of evaluating electrochemical properties of an exemplary positive electrode active material in Example 9 according to an exemplary embodiment of the present invention.

FIG. 13 is a graph illustrating results of evaluating electrochemical properties of an exemplary positive electrode active material in Example 10 according to an exemplary embodiment of the present invention.

FIG. 14A is a diagram illustrating a result of an X-ray diffraction analysis of a positive electrode material according to Comparative Example 2.

FIG. 14B is an SEM photograph illustrating the positive electrode material according to Comparative Example 2.

### DETAILED DESCRIPTION

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, embodiments of the present invention will be described in detail with reference to the accompanying drawings. However, the present invention is not limited to embodiments disclosed below but will be implemented in various forms. The embodiments are provided by way of example only so that those skilled in the art can fully understand the present invention and the scope of the present invention.

In an aspect, a positive electrode material or positive electrode active material for a lithium secondary battery may be a material forming a positive electrode applied to a lithium secondary battery. The positive electrode active material may be formed by doping a positive electrode active material with a dopant (Me) having an oxidation number of 2 to 6. Thus, a lithium secondary battery includes a positive electrode including a positive electrode active material; a negative electrode including a negative electrode active material; and an electrolyte. In this case, the positive electrode active material may include, or may be doped with a dopant (Me) having an oxidation number of 2 to 6 to form a positive electrode material.

The positive electrode active material may include a Li—[Mn—Ti]—O-based material so that lithium is reversibly intercalated and deintercalated.

Preferably, the positive electrode material may be Li_{1.2+y}[Mn_{0.4}Ti_{0.4}]₁₋ₓMeₓO₂, the dopant (Me) may be one or more selected from W, Cr, Al, Ni, Fe, Co, V, and Zn, and 0.025≤x≤0.0 and −0.02≤y≤0.02.

The transition metal having an oxidation number of 2 to 6 may be selected as a dopant (Me) to be doped on the positive electrode active material.

For example, when a transition metal having an oxidation number of 1, such as Li₂O, Na₂O, or K₂O, is doped on the positive electrode active material through a starting material, when considering an oxidation number in a structure, the amount of Li is increased, and thus it is difficult to form a monolithic structure due to an excessive amount of Li. In addition, a transition metal having an oxidation number of greater than 6 may be excluded as the dopant (Me) because it is not in a stable state.

Meanwhile, the positive electrode material obtained by doping the positive electrode active material with the dopant (Me) may be represented by Li_{1.2+y}[Mn_{0.4}Ti_{0.4}]₁₋ₓMeₓO₂. In a composition that is out of an atomic ratio or a molar ratio represented in Li_{1.2+y}[Mn_{0.4}Ti_{0.4}]₁₋ₓMeₓO₂, that is, represented numerical ranges of x and y, a large amount of impurities may be formed due to an excessive amount of Li.

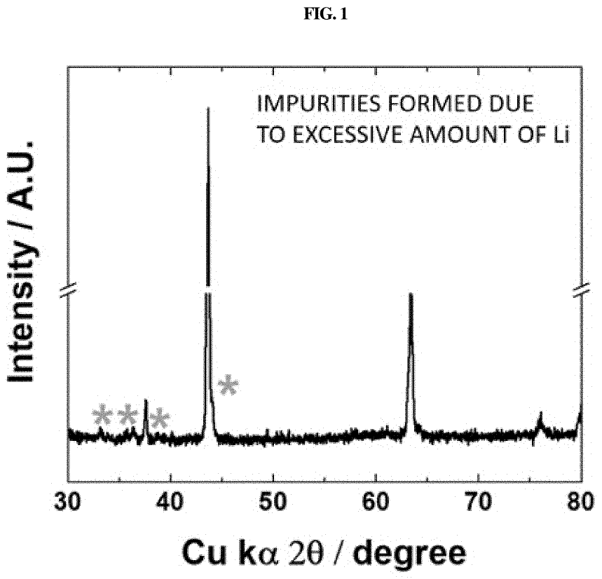

FIG. 1 is a diagram illustrating a result of an X-ray diffraction analysis of a positive electrode material in which impurities are formed due to an excessive amount of Li.

As illustrated in FIG. 1, it was confirmed that, when the positive electrode material obtained by doping the positive electrode active material with the dopant (Me) had a composition that is out of the numerical ranges of x and y, a large amount of impurities were formed.

### EXAMPLE

The present invention will be described with reference to the positive electrode materials according to Examples and Comparative Examples.

First, various samples having different components of the dopant (Me) doped on the positive electrode active material were prepared.

### [Example 1] (Sample 1)

Li₂CO₃ (addition of 3 wt % excess of Li₂CO₃), Mn₂O₃ (synthesized by sintering MnCO₃), TiO₂, and WO₃ were mixed in an anhydrous ethanol solvent in a 45 ml jar. A molar ratio of each component was adjusted to the composition of Li_{1.2}[(Mn_{0.4}Ti_{0.4})_{0.95}W_{0.05}]O₂. In this case, 5 g of a ZrO₂ ball (10 mm), 10 g of a ZrO₂ ball (5 mm), and 4 g of a ZrO₂ ball (1 mm) were added. Ball milling was performed in 17 sets each of 15 minutes at a condition of 300 rpm/5 h. After performing the ball milling, washing was performed with ethanol, drying was performed, and then pellets were formed. Sintering was performed at a temperature of 900° C. for 12 hours in an Ar atmosphere, thereby obtaining powder.

Thereafter, a primary carbon ball milling (300 rpm/6 h, 20 sets each of 15 minutes) [active material:acetylene black=9 wt %:1 wt %, ZrO₂ ball: 10 mm×3 g, 5 mm×9 g, 1 mm×2 g] was performed, and then a secondary carbon ball milling (300 rpm/12 h, 40 sets each of 15 minutes) [ZrO₂ ball: 1 mm×5.5 g] was performed.

### [Example 2] (Sample 2)

Example 2 was performed in the same manner as that of Example 1, and a ratio of Cr used as a dopant (Me) was adjusted to 0.05.

### [Example 3] (Sample 3)

Example 3 was performed in the same manner as that of Example 1, and a ratio of Al used as a dopant (Me) was adjusted to 0.05.

### [Example 4] (Sample 4)

Example 4 was performed in the same manner as that of Example 1, and a ratio of Ni used as a dopant (Me) was adjusted to 0.05.

### [Example 5] (Sample 5)

Example 5 was performed in the same manner as that of Example 1, and a ratio of Fe used as a dopant (Me) was adjusted to 0.05.

### [Example 6] (Sample 6)

Example 6 was performed in the same manner as that of Example 1, and a ratio of Co used as a dopant (Me) was adjusted to 0.05.

### [Example 7] (Sample 7)

Example 7 was performed in the same manner as that of Example 1, and a ratio of V used as a dopant (Me) was adjusted to 0.05.

### [Example 8] (Sample 8)

Example 8 was performed in the same manner as that of Example 1, and a ratio of Zn used as a dopant (Me) was adjusted to 0.05.

### [Example 9] (Sample 9)

Example 9 was performed in the same manner as that of Example 1, and a ratio of Al used as a dopant (Me) was adjusted to 0.025.

### [Example 10] (Sample 10)

Example 10 was performed in the same manner as that of Example 1, and a ratio of V used as a dopant (Me) was adjusted to 0.025.

### Comparative Example 1

Comparative Example 1 was performed in the same manner as that of Example 1 without performing doping.

### Comparative Example 2

Comparative Example 2 was performed in the same manner as that of Example 1, and a ratio of Mo used as a dopant (Me) was adjusted to 0.05.

Under the conditions described above, an X-ray diffraction analysis, an SEM photograph, and electrochemical properties of each of the prepared positive electrode materials according to Examples and Comparative Examples were evaluated. The results are illustrated in the drawings.

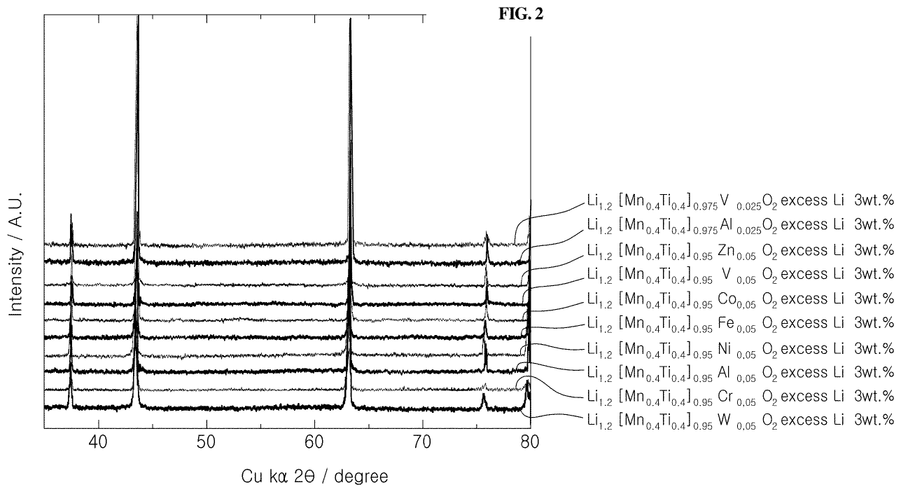

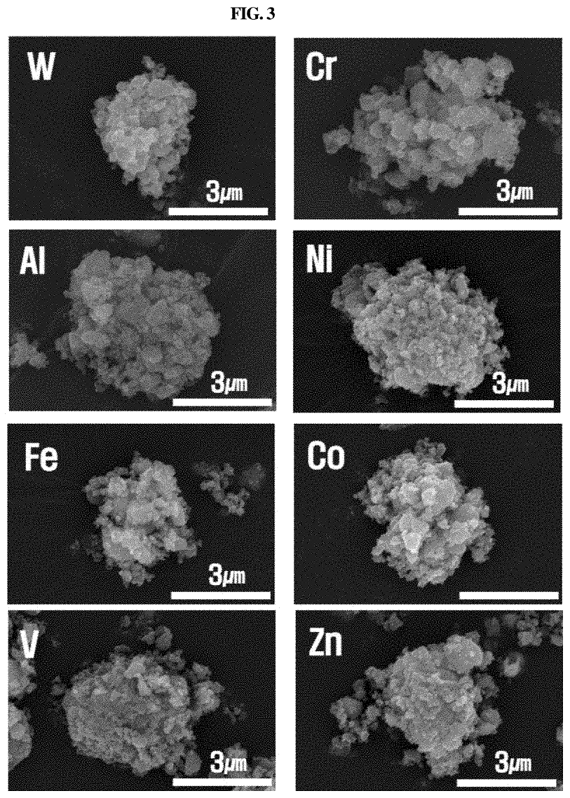

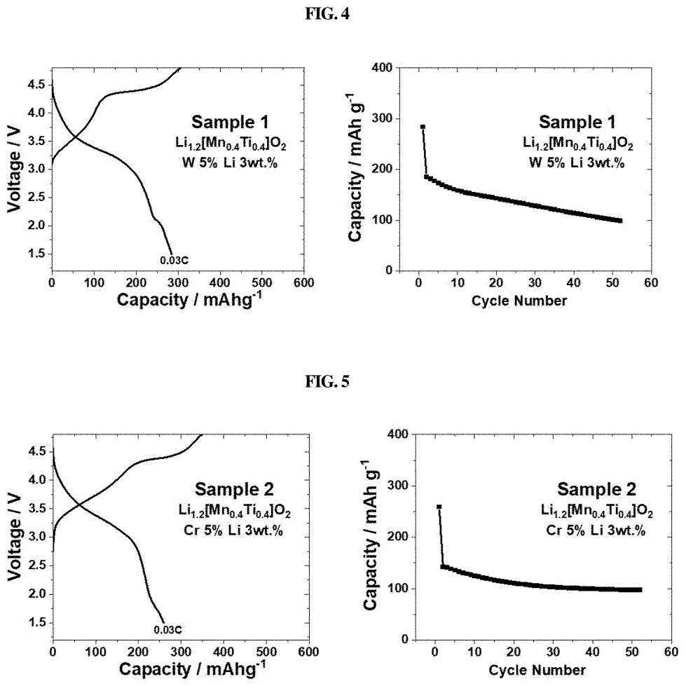

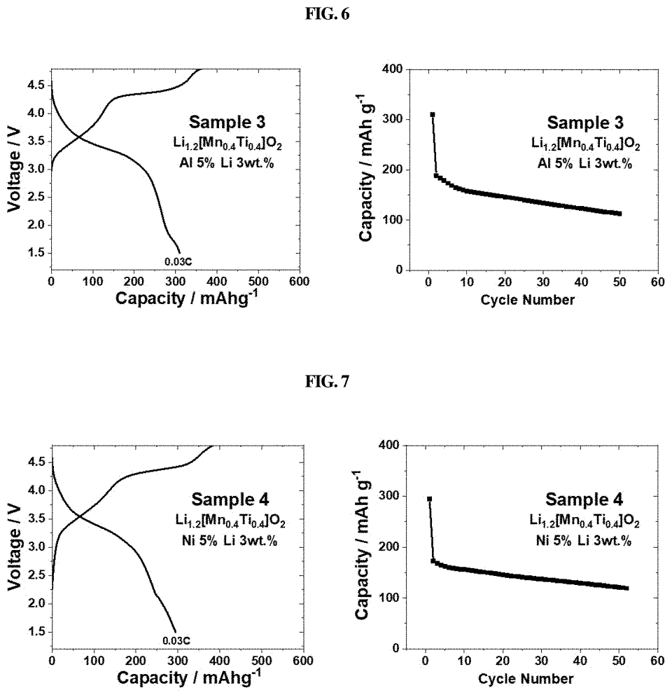

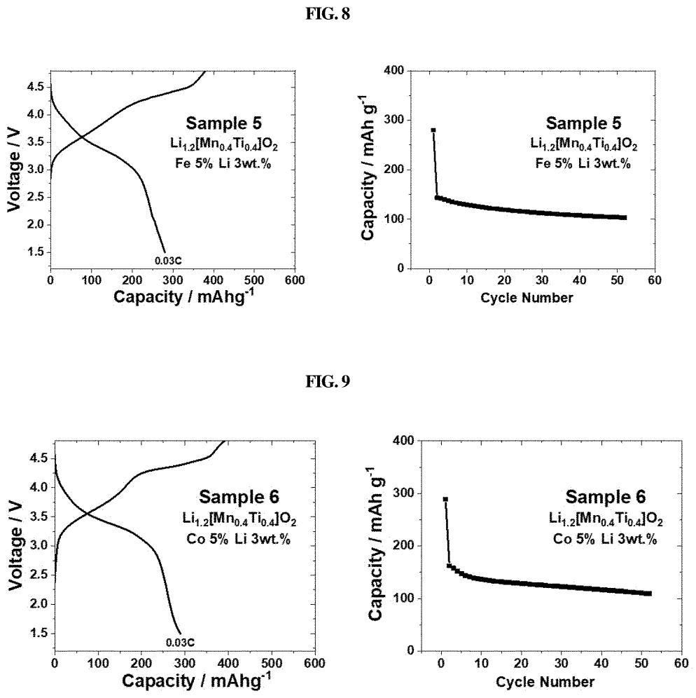

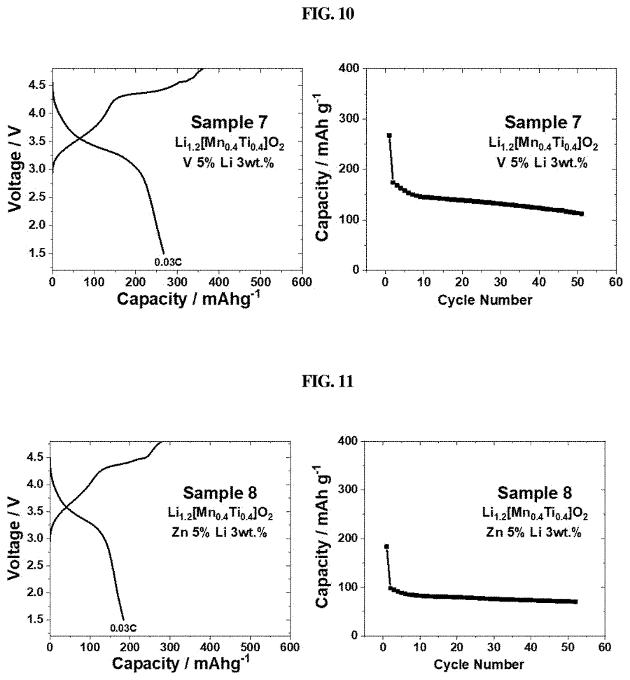

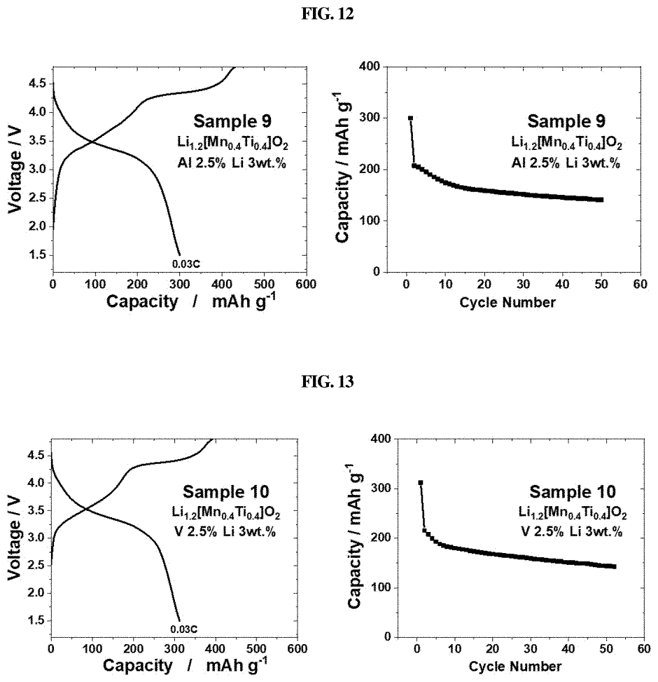

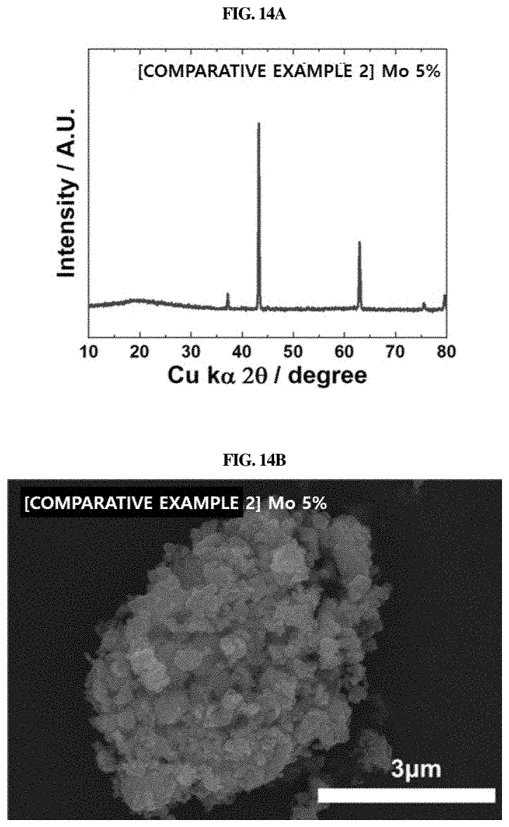

FIG. 2 is a diagram illustrating the result of the X-ray diffraction analysis of the positive electrode material according to Examples and Comparative Examples. FIG. 3 is the SEM photographs illustrating the positive electrode materials according to various Examples of the present invention. FIGS. 4 to 13 are graphs illustrating the results of evaluating the electrochemical properties of the positive electrode active materials in Examples 1-10 according to various exemplary embodiments of the present invention. FIG. 14A is a diagram illustrating the result of the X-ray diffraction analysis of the positive electrode material according to Comparative Example 2. FIG. 14B is the SEM photograph illustrating the positive electrode material according to Comparative Example 2.

First, when comparing FIG. 2 and FIG. 3 with FIG. 14A and FIG. 14B, respectively, in the positive electrode materials of Examples 1 to 10 and the positive electrode material of Comparative Example 2, the types of dopants (Me) are different from each other. The dopants (Me) of Examples 1 to 10 are W, Cr, Al, Ni, Fe, Co, V and Zn, and the dopant (Me) of Comparative Example 2 is Mo.

As illustrated in FIGS. 2 and 14A, it could be confirmed that the positive electrode materials obtained by using W, Cr, Al, Ni, Fe, Co, V and Zn, which are the types of dopants (Me) presented in the present invention, have almost the same lattice constant and the same ratio of a 220 peak (about 63 degrees) to a 200 peak (about 43 degrees) that is a main peak of a cubic Fm-3 structure.

On the other hand, in Comparative Example 2, Mo was used as a dopant instead of the dopant (Me) presented in the present invention. It could be confirmed that the positive electrode material obtained by using Mo as the dopant (Me) is different in a lattice constant (a-axis) and a ratio of a 220 peak (about 63 degrees) to a 200 peak (about 43 degrees) that is a main peak of a cubic Fm-3 structure from the positive electrode materials in FIG. 2.

In addition, as illustrated in FIGS. 3 and 14B, it could be confirmed that the positive electrode materials obtained by using W, Cr, Al, Ni, Fe, Co, V and Zn, which are the types of dopants (Me) presented in the present invention, generally have a shape in which fine particles of about 1 μm or less are in an aggregated form having a size of about 3 μm.

In addition, in Comparative Example 2, Mo was used as a dopant instead of the dopant (Me) presented in the present invention. It could be confirmed that the positive electrode material obtained by using Mo as the dopant (Me) generally also has a shape in which fine particles of about 1 μm or less are in an aggregated form having a size of about 3 μm.

Therefore, it could be confirmed that the positive electrode materials obtained by using W, Cr, Al, Ni, Fe, Co, V and Zn, which are the types of dopants (Me) presented in the present invention and the positive electrode material obtained by using Mo as the dopant (Me) have a similar shape of fine particles, but have different lattice constants (a-axis) and different ratios of the 220 peak (about 63 degrees) to the 200 peak (about 43 degrees) that is the main peak of the cubic Fm-3 structure.

FIGS. 4 to 13 are the graphs illustrating the results of evaluating electrochemical properties according to various Examples of the present invention. FIGS. 4 to 13 are the graphs illustrating a first cycle charge-discharge curve of the positive electrode material and the results of the cycle.

It could be confirmed that, in all the positive electrode materials obtained by using W, Cr, Al, Ni, Fe, Co, V and Zn, which are the types of dopants (Me) presented in the present invention, a high reversible capacity is shown at a similar level, and a lifespan is also excellent.

Therefore, it could be confirmed that, in a case where the positive electrode material is Li_{1.2+y}[Mn_{0.4}Ti_{0.4}]₁₋ₓMeₓO₂, any one of W, Cr, Al, Ni, Fe, Co, V, and Zn is used as the dopant (Me), and 0.025≤x≤0.0 and −0.02≤y≤0.02, a high reversible capacity and an excellent lifespan may be implemented.

According to an embodiment of the present invention, it is possible to form a positive electrode material that implements a greater discharge capacity than a positive electrode according to the related art without the use of Ni and Co, and thus to implement the positive electrode material having a high energy density.

In particular, by doping the positive electrode active material with the dopant (Me) having an oxidation number of 2 to 6, it is possible to improve an atmospheric instability, structural instability, short lifespan, and low power characteristics of the positive electrode active material.

Therefore, it is possible to build a pure electric vehicle model and thus to save the manufacturing cost of a battery-based pure electric vehicle as compared to a hybrid or derivative electric vehicle in which a driving apparatus is applied in a designed vehicle structure.

Although the present invention has been shown and described with respect to specific embodiments, it will be apparent to those having ordinary skill in the art that the present invention may be variously modified and altered without departing from the spirit and scope of the present invention as defined by the following claims.

What is claimed is:

1. A positive electrode material for a lithium secondary battery, comprising:
a positive electrode active material comprising a Li—[Mn—Ti]—O-based material and a dopant (Me) having an oxidation number of 2 to 6.

2. The positive electrode material of claim 1, wherein the positive electrode active material comprises the Li—[Mn—Ti]—O-based material doped with the dopant (Me).

3. The positive electrode material of claim 1, wherein lithium is reversibly intercalated and deintercalated by the positive electrode active material.

4. The positive electrode material of claim 1, wherein the positive electrode material is Li_{1.2+y}[Mn_{0.4}Ti_{0.4}]₁₋ₓMeₓO₂,
the dopant (Me) is one or more selected from W, Cr, Al, Ni, Fe, Co, V, and Zn, and
0.025≤x≤0.0 and −0.02≤y≤0.02.

5. A lithium secondary battery comprising:
a positive electrode including the positive electrode material of claim 1;
a negative electrode including a negative electrode active material; and
an electrolyte.

6. A lithium secondary battery comprising:
a positive electrode including the positive electrode material comprising Li_{1.2+y}[Mn_{0.4}Ti_{0.4}]₁₋ₓMeₓO₂ wherein the Me is one or more selected from W, Cr, Al, Ni, Fe, Co, V, and Zn, and 0.025≤x≤0.0 and −0.02≤y≤0.02;
a negative electrode including a negative electrode active material; and
an electrolyte.
